(19) United States
(12) Patent Application Publication
(10) Pub. No.: US 2015/0294544 A1
(43) Pub. Date: Oct. 15, 2015

(54) INTERPRETATIVE ALARM IMPLEMENT AND METHOD OF USE

(71) Applicant: Helen L. Betts, Kansas City, KS (US)

(72) Inventor: Helen L. Betts, Kansas City, KS (US)

(21) Appl. No.: 14/248,760

(22) Filed: Apr. 9, 2014

(51) Int. Cl. G08B 17/10; G08B 3/10

(52) U.S. Cl. CPC G08B 17/10; G08B 3/10

(57) ABSTRACT

A method of and implement for alerting a user to a condition, including detecting the condition, producing a non-lingual sound and/or transmitting a communication at an alarm location, receiving the sound and/or communication at the user location, and generating an audible, visual, and/or haptic alert comprising a lingual message when the sound and/or communication is received at the user location.

### BACKGROUND OF THE INVENTION

1. Technical Field

The present invention relates to alarms, such as smoke alarms and carbon monoxide detectors, and methods of alerting users to potentially dangerous conditions. More particularly, the invention relates to an interpretive implement for and method of alerting a user to such conditions, by generating an alert that is more readily received and understood by the user, when a conventional audible alarm is actuated.

2. Background Art

A variety of audible alarms are often used to protect the inhabitants of residential and commercial dwellings. Among them, smoke alarms, carbon monoxide detectors, and burglar alarms are well known systems that protect residential homes from fire, smoke, and carbon monoxide accumulation, as well as home invasion. These alarms are typically stationed in common areas such as hallways or kitchens, and work to produce a high amplitude sound that can be heard throughout the structure when the dangerous condition is detected. The sound is typically a monotone or periodic beep, buzz, or similar sound that presents a frequency, amplitude, and timing/pattern.

It is appreciated by those of ordinary skill in the art that identification of alarm sounds pose a challenge for certain “dependent” users, such as small children, and the mentally or hearing impaired. First, the alarm sounds are non-lingual, such that they do not convey meaning without further instruction and prior exposure. Moreover, there exists many other household appliances and appurtenances that produce similar sounds (e.g., when an oven, toaster, or microwave has reached a predetermined temperature, etc.), thus, requiring the alarm sound to be distinguished by the user. Finally, even when prior instructions has been given, it is appreciated that dependent users often panic or forget what to do when such dangerous conditions are present.

For all users, conventional alarms present other concerns in the art. For example, the sound produced may not be sufficient to awaken a sleeping user, depending upon the relative location of the user and alarm, and the manner in which the user sleeps. Further, and with particular respect to smoke, it is appreciated that an audible alarm does nothing to help the user see the escape path.

Thus, there remains a need in the art for an improved alarm system that better communicates the presence of a dangerous condition to users, and particularly, dependent users.

### BRIEF SUMMARY

The present invention concerns an interpretive alarm implement for and improved method of alerting a user to a dangerous condition, such as fire, smoke, or carbon monoxide infiltration, and home invasion. In a first preferred embodiment, the invention is useful for identifying the non-lingual sound produced by a conventional audible alarm and generating a lingual message that includes instruction when the sound is identified. In a second preferred embodiment, the implement is communicatively coupled to an audible alarm through short range communication.

By generating a lingual message when the audible alarm is actuated, the inventive implement is useful for generating an alert that is more readily understood by dependent users; and by using a familiar voice, such as that of their mother or father, to generate the lingual message, and where the implement composes a stuffed animal, the invention is useful for generating an alert that is more readily received by children during such conditions. Where the lingual message is modifiable, the invention is adapted for use with a variety of users (e.g., users of differing nationality). The invention is further useful for providing means for awakening a sleeping user, where the alarm sound is insufficient. Once awakened, the invention is yet further useful for aiding the user in escaping. For example, in preferred embodiments, the inventive implement includes lights operable to illuminate an escape path, and/or an emergency aid, such as a fabric particle mask, to help the user escape. Thus, the invention is useful for saving more lives when a dangerous condition is encountered. Finally, where the implement is portable, the invention provides a life saving measure that is able to travel with, and otherwise remain in close proximity to the user.

In a first aspect, the invention recites an interpretive alarm implement adapted for use by a user and with an audible alarm operable to produce a non-lingual sound when a condition is detected. The implement includes a receiver communicatively coupled to the alarm, and operable to receive the sound. The implement further includes a controller configured to analyze the sound, and compare the sound to a trigger, and finally, an alert generator configured to generate an alert when the sound matches the trigger. The alert is operable to facilitate and/or direct the user to perform an action that allays or avoids the condition.

A second aspect of the invention involves a method of autonomously alerting a user to a dangerous condition. The method includes the steps of detecting the condition at a first location, and generating a communication only when the condition is detected at the first location, and transmitting the communication from the first location. At a second location, the communication is received, and an audible alert including a lingual message is generated when the communication is received. Communication may be had using one of various short range technologies.

Other aspects and advantages of the present invention, including a preferred implement composing a portable stuffed animal will be apparent from the following detailed description of the preferred embodiment(s) and the accompanying drawing figures.

### BRIEF DESCRIPTION OF THE DRAWINGS

A preferred embodiment(s) of the invention is described in detail below with reference to the attached drawing figures of exemplary scale, wherein:

FIG. 1 is an elevation of an interpretive alarm implement composing a portable stuffed animal, in accordance with a preferred embodiment of the invention;

FIG. 2 is a scene of a user sleeping with the stuffed animal shown in FIG. 1, and a conventional audible smoke detector producing a sound and triggering the implement, in accordance with a preferred embodiment of the invention;

FIG. 3 is a schematic diagram of the alarm including an exemplary transmitter, in accordance with a preferred embodiment of the invention; and

FIG. 4 is a schematic diagram of the implement including an exemplary receiver and first and second LED's and vibratory motors, in accordance with a preferred embodiment of the invention.

### DETAILED DESCRIPTION

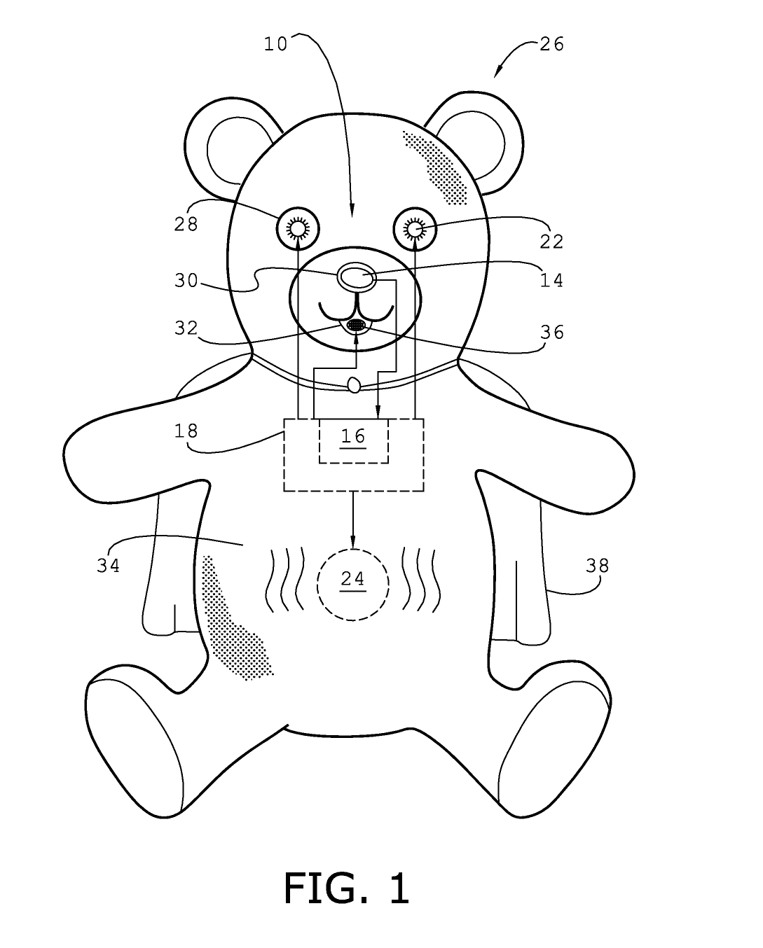

The following description of the preferred embodiments is merely exemplary in nature and is in no way intended to limit the invention, its application, or uses. An interpretive alarm implement 10 adapted for use by a user 100, and more particularly a dependent user, such as a child or mentally/hearing impaired adult, is described and illustrated (FIGS. 1-4) herein. The implement 10 and an audible alarm 12 are cooperatively configured and comprise suitable power sources (e.g., wall power, 9V battery, etc.) to effect the intended benefits of the invention, which is primarily to interpret the production of a non-lingual alarm sound for a user spaced from the alarm 12, and who might otherwise not hear or understand the meaning of the sound.

The implement 10 functions by generating a more readily received and understood lingual (i.e., spoken) message correlated to the detection, and/or a visual or haptic alert that further causes, or facilitates the performance of an action (e.g., waking up, opening the window, exiting, etc.). The implement 10 and alarm 12 are cooperatively configured such that the implement 10 may be spaced from the alarm 12 a predetermined maximum distance, more preferably, up to 50 feet, and most preferably up to 200 feet. In the preferred embodiment, the alarm 12 is operable to detect a dangerous condition, such as a predetermined quantity/concentration of an airborne particulate or gaseous constituent, such as smoke, carbon monoxide, natural gas, etc; however, the invention may also be used with burglar alarms 12 operable to detect home invasion.

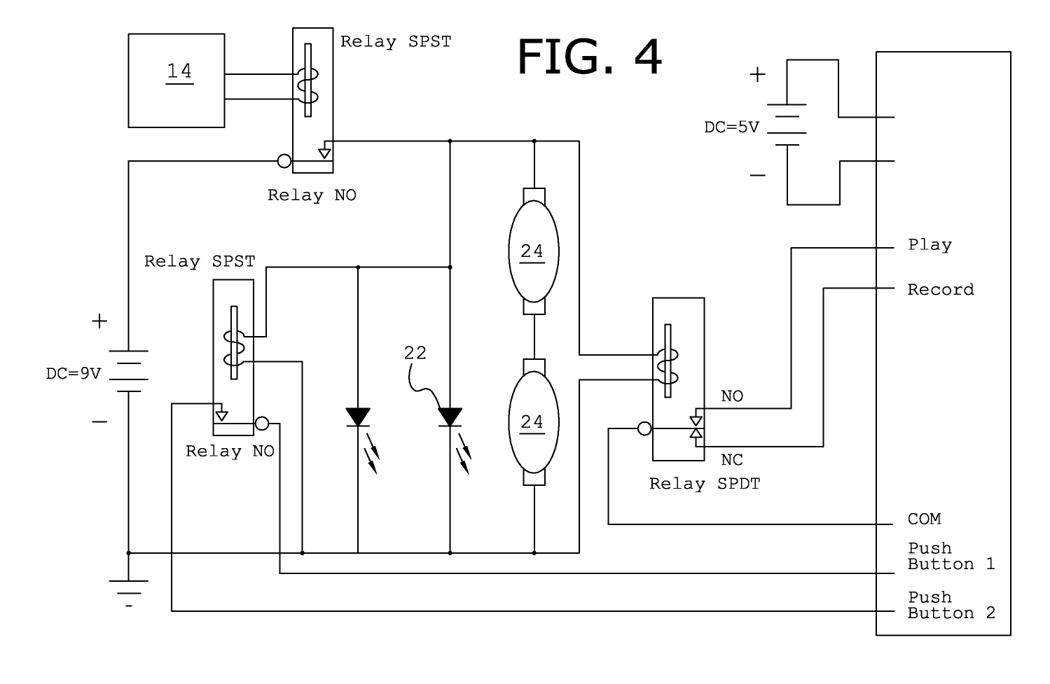

In a first aspect of the invention, the implement 10 may function by receiving and analyzing the sound, and then comparing it to a pre-set trigger. When the sound matches the trigger, the implement 10 generates an alert including a lingual message, visual, and/or haptic alert, and more preferably, a plurality of these types alert. Thus, the implement 10, in this configuration, may include a receiver 14 operable to receive the sound (FIGS. 1 and 4). The receiver 14 may therefore comprise an electret microphone and a controller 16 having stored thereupon and the ability to execute sound analyzing software. The controller 16 compares the sound to a trigger, for example, by comparing at least one of the frequency (or pitch), amplitude (or loudness), timing, pattern or other characteristic of the sound to the same type of parameter established as that of the sound or category of sounds being produced at the intended spacing. That is to say, where the sound presents a first frequency, amplitude, timing, and/or pattern, and the trigger presents a second or threshold frequency, amplitude, timing, and/or pattern, the controller 16 is configured to analyze the frequencies, amplitudes, timings, and/or patterns, and the alert is generated when the first frequency, amplitude, timing, and/or pattern matches the second frequency, amplitude, timing, and/or pattern. In this regard, it is appreciated that many alarms generally produce sounds sharing a range of characteristics. For the hearing impaired, for example, a vibratory alert may be generated for any monotone sound bearing a minimum amplitude or any periodic sound of minimum amplitude and constant timing.

In a preferred embodiment, the trigger is preferably pre-set by actuating the alarm 12 (e.g., testing a smoke detector, etc.) and recording or determining the pertinent parameters of the sound from the general location of the implement 10. The implement 10 would then be triggered when the sound is reproduced. The preferred trigger is able to be modified, so as to be able to match a plurality of differing alarm sounds or locations/spacing.

Alternatively, direct sound activation may be employed. For example, the implement 10 may be triggered mechanically by the frequency and/or amplitude of the sound, and to that end may include a sound sensor, or other suitable device that takes the place of the receiver 14 and controller 16. In another alternative, a microphone of suitable sensitivity may be used as part of a sound-trigger circuit to selectively energize and de-energize the circuit. Sound-trigger circuits, such as generally employed by “clap-on” devices, are readily ascertained and appreciated by those of ordinary skill in the art.

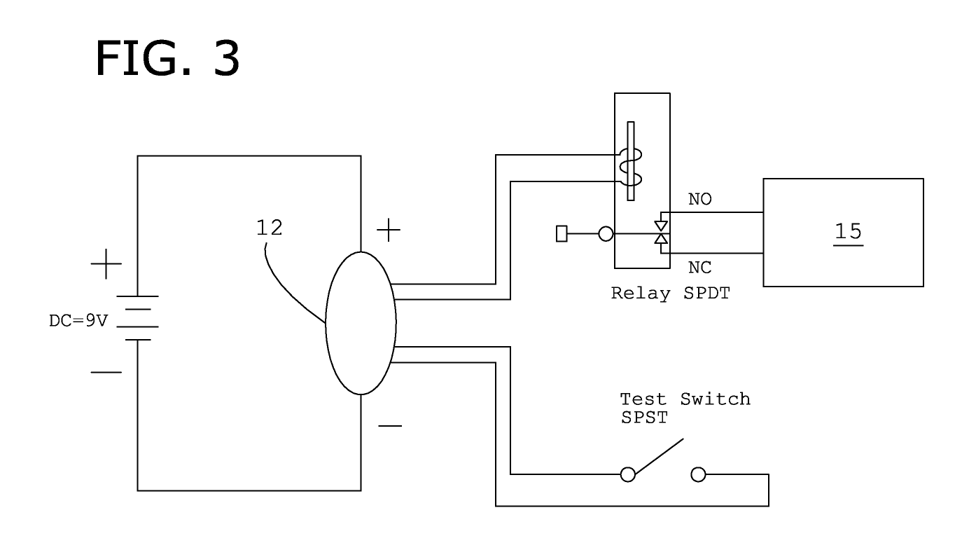

In a second aspect of the invention, the implement 10 does not interpret the alarm sound directly, and as such, is not required to constantly monitor and analyze all sounds received. Instead, the implement is communicatively coupled to the alarm 12 via short range communication. When the condition is detected, the alarm 12 sends a communication to the implement 10 (in addition to generating an audible alarm); and the controller 16 is configured to generate the alert upon receipt of the communication. More preferably, the alarm 12 is configured to broadcast the communication, such that multiple implements 10 within a dwelling receive the communication. Suitable communication systems include, without limitation, Radio Frequency (RF), Infrared, optical based technologies, wireless fidelity (WiFi), and Bluetooth™, wherein the term “WiFi” refers to the IEEE 802.11 family of wireless networking standards for wireless local area networks (WLANs). Thus, in this configuration, the implement 10 includes a receiver 14 communicatively coupled to a transmitter 15 associated with the alarm 12 (FIGS. 3 and 4). It is appreciated that where a sound-trigger circuit is employed, the communication is the sound wave of the non-lingual alarm or a characteristic thereof.

In both aspects, the implement 10 includes an alert generator 18 configured to generate an alert 20 when the sound matches the trigger or the communication is received. The alert is operable to cause, facilitate, and/or direct the user 100 to perform an action that allays or avoids the condition. As previously mentioned, the alert 20 preferably includes a lingual message instructing the user 100 to perform an emergency action (e.g., “Wake up Ashely! Go outside now!”); and the lingual message is preferably a digital voice recording of someone familiar to the user 100 (e.g., mother, father, etc.). In a preferred embodiment, the message is modifiable, e.g., manually erasable and reproducible, for example, by the parent/guardian of the user 100. As such, the same implement 10 may be used by users who speak different languages, or to alert a user to different types of alarms 12.

More preferably, the alert generator 18, in addition to a lingual message, is operable to produce a visual alert, such as a quantum of light sufficient to awaken a sleeping user, and illuminate a dark or smoke-filled room, where applicable. As such, the generator 18 preferably includes at least one light source 22 (e.g., small LED flashlight, etc.). Alternatively, the alert generator 18 may be configured to produce a haptic alert in addition to the lingual message. For example, the alert generator 18 may further include a vibratory element 24, e.g., at least one vibrating motor (FIG. 4), piezoelectric composite, etc., so as to produce vibrations strong enough to awaken a user sleeping thereby or thereupon. Most preferably, to awaken a sleeping user, the alert generator 18 is configured to concurrently produce an audible, visual, and haptic alert when triggered.

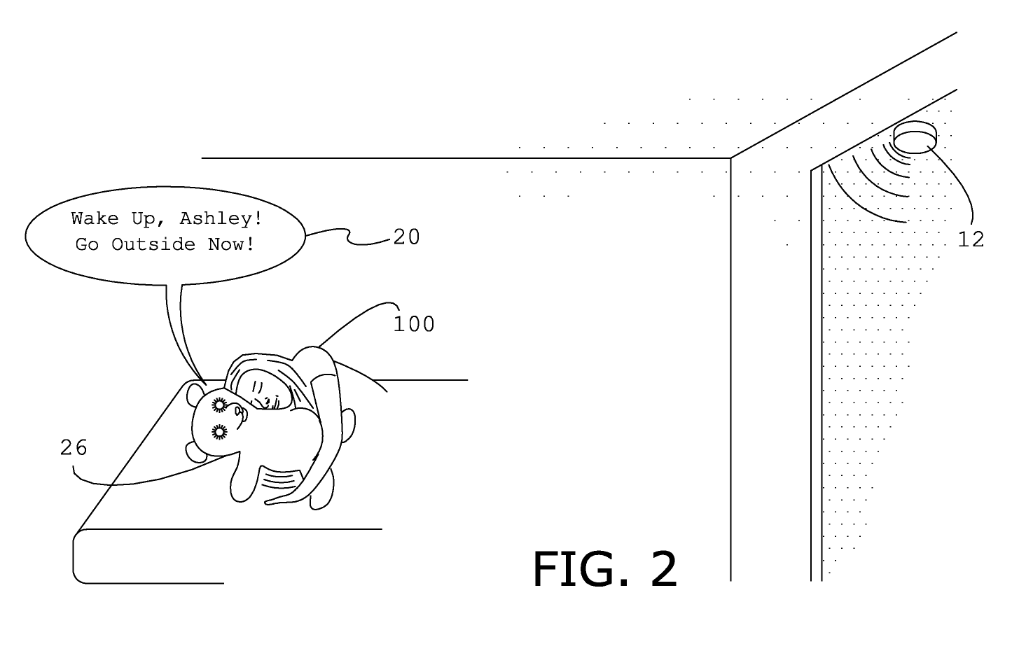

In the preferred embodiment of the invention, the implement 10 composes a portable stuffed animal 26 (FIGS. 1-2), so as to comfort and facilitate use by children. It is certainly within the ambit of the invention, however, for the implement to compose other common bedroom or children's playroom amenities, such as, for example, a wall clock, headboard, pillow, figurine, ornament, night stand, or lamp. Other designs may include sports objects (e.g., football, soccer ball, etc.) for teens and adults; in this setting, the familiar voice may be that of a star athlete. Asides from the implement 10 functionally housed therein, the portable stuffed animal 26 is conventionally constructed of a soft exterior layer, and interior cushioning material (not shown), and may present any of a variety of animal forms (e.g., teddy bear, dog, cat, monkey, etc.). The preferred stuffed animal 26 defines a pleasant face including two eyes 28, a nose 30, and a mouth 32, and a rotund body 34. To facilitate reception of instructions by children, the implement 10 and stuffed animal 26 are cooperatively configured such that the lingual message appears to emanate from the mouth 32 (for example, a speaker 36 composing the implement 10 may be placed in the mouth 32), the light from the eyes 28 and/or nose 30, and the haptic alert (e.g., vibrations, etc.) from the body 34 (FIG. 1).

An emergency aid 38 operable to aid the user in performing an action may be securely retained relative to the body 34. For example, a teddy bear 26 may don a fabric particle cape 38 (FIG. 1); or a stuffed kangaroo (not shown) may retain a fabric particle mask within its pouch, which can be worn to help reduce smoke inhalation during escape from a burning structure. Lastly, the implement 10 is preferably configured such that the alert is continually generated until the user, or the parent of the user manually terminates it.

This invention has been described with reference to exemplary embodiments; it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

The terms “a” and “an” herein do not denote a limitation of quantity, but rather denote the presence of at least one of the referenced item. The suffix “(s)” as used herein is intended to include both the singular and the plural of the term that it modifies, thereby including one or more of that term. Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments.

What is claimed is:

1. An interpretive alarm implement adapted for use by a user and with an audible alarm operable to produce a non-lingual sound when a condition is detected, said implement comprising:
a receiver spaced from the alarm, and operable to receive the sound;
a controller communicatively coupled to the receiver, and configured to analyze the sound and compare the sound to a trigger; and
an alert generator configured to generate an audible, visual, or haptic alert when the sound matches the trigger, wherein the alert is operable to cause, facilitate, and/or direct the user to perform an action that allays or avoids the condition.

2. The implement as claimed in claim 1, wherein the alert includes a lingual message instructing the user to perform the action.

3. The implement as claimed in claim 2, wherein the message is a digital voice recording.

4. The implement as claimed in claim 2, wherein the message is manually erasable and reproducible.

5. The implement as claimed in claim 1, wherein the alert generator includes at least one light source, and the alert includes a quantum of light.

6. The implement as claimed in claim 1, wherein the alert generator includes at least one vibratory motor.

7. The implement as claimed in claim 1, wherein the trigger is able to be modified, so as to be able to match a plurality of differing alarm sounds.

8. The implement as claimed in claim 7, wherein the trigger is set by recording the sound, such that the trigger is matched when the sound is reproduced.

9. The implement as claimed in claim 1, wherein the generator is configured to concurrently produce an audible, visual, and haptic alert when the sound matches the trigger.

10. The implement as claimed in claim 1, wherein the implement composes a stuffed animal, wall clock, bed, pillow, figurine, ornament, night stand, lamp, or sports object.

11. The implement as claimed in claim 1, wherein the sound presents a first frequency, amplitude, timing, and/or pattern, the trigger includes a second frequency, amplitude, timing, and/or pattern, the controller is configured to analyze the frequencies, amplitudes, timings, and/or patterns, and the alert is generated when the first frequency, amplitude, timing, and/or pattern matches the second frequency, amplitude, timing, and/or pattern.

12. A portable stuffed animal adapted for use by a user, and with an audible alarm operable to produce a non-lingual sound when a condition is detected, said stuffed animal comprising,
a soft exterior layer;
a receiver communicatively coupled to the alarm, and operable to receive the sound;
a controller configured to analyze the sound, and compare the sound to a trigger; and
an alert generator configured to generate an alert including a lingual message, when the sound matches the trigger,
wherein the alert is operable to facilitate and/or direct the user to perform an action that allays or avoids the condition,
wherein the layer defines first and second eyes, a nose, and a mouth, and the generator includes at least one LED disposed in the eyes and/or nose, and a speaker from which the message emanates disposed in the mouth.

13. The stuffed animal as claimed in claim 12, further comprising:
an emergency aid securely retained relative to the layer and operable to aid the user in performing the action.

14. The stuffed animal as claimed in claim 13, wherein the aid is a fabric particle mask or cape.

15. A method of autonomously alerting a user to a dangerous condition, said method comprising:
a. detecting the condition at a first location, and generating a non-lingual sound and communication only when the condition is detected at the first location;
b. transmitting the communication from the first location;
c. receiving the communication at a second location; and
d. generating an audible alert including a lingual message at the second location when the communication is received.

16. The method as claimed in claim 15, wherein the communication is a short range wireless communication.

17. The method as claimed in claim 15, wherein the communication is broadcasted.

18. The method as claimed in claim 15, wherein the communication is a characteristic of the non-lingual sound, and steps c) and d) are performed employing a sound-trigger circuit.

19. The method as claimed in claim 15, wherein step d) further includes the steps of playing a digital sound recording of a voice familiar to the user.

20. The method as claimed in claim 15, wherein step d) further includes the steps of generating a quantum of light and/or vibrations.
